(19) United States
(12) Patent Application Publication
(10) Pub. No.: US 2026/0220928 A1
(43) Pub. Date: Jul. 30, 2026

(54) UNDERGROUND DATA MANAGEMENT DEVICE, METHOD, AND PROGRAM

(71) Applicant: GEO SEARCH CO., LTD., Tokyo (JP)

(72) Inventors: Satoshi Okawara, Tokyo (JP); Hoshibumi Ichiyanagi, Tokyo (JP)

(21) Appl. No.: 19/385,786

(22) Filed: Nov. 11, 2025

(30) Foreign Application Priority Data
Nov. 27, 2024 (JP) 2024-206641

(51) Int. Cl. G06V 10/80; G01S 13/88; G06V 10/75; G06V 20/56

(52) U.S. Cl. CPC G06V 10/806; G01S 13/885; G06V 10/758; G06V 20/588

(57) ABSTRACT

There is provided an underground data management device that acquires a road surface image and underground data in association with acquisition positions along a plurality of measuring lines which are set such that imaging ranges of the road surface images partially overlap, selects a reference measuring line from the plurality of measuring lines, divides the road surface image into a plurality of blocks along the measuring line, and specifies a relative position of each of the other measuring lines with respect to the reference measuring line for each block by associating the block of the road surface image of the reference measuring line and the block of the road surface image of each of the other measuring lines such that feature points in the images match each other, and manages, for each block, the underground data by using the relative position with respect to the reference measuring line.

### BACKGROUND

### Technical Field

The present disclosure relates to an underground data management device, an underground data management method, and an underground data management program.

### Related Art

For example, in a task of inspecting underground data such as a position of a buried pipe, planar underground data may be created and analyzed from data acquired by a ground penetrating radar (GPR) device or the like. In this case, it is necessary to associate a position where the underground data is acquired with the underground data. For example, a measuring line is physically provided by stringing a string or drawing a line with chalk on a road surface at a point with known position information, and then underground data is acquired by moving the GPR device along the measuring line. In a case where underground data is acquired along a plurality of measuring lines in an inspection range, underground data for the entire inspection range is created by arranging and joining underground data created for each measuring line based on relative position information of each measuring line. However, it takes time and effort to physically provide the measuring line. In addition, depending on characteristics of the inspection range, such as a state of a road surface, a shape of the inspection range, and a situation of a pedestrian, it may be difficult to physically provide a measuring line, such as a case where only a skilled worker can draw a measuring line.

Further, for example, by using an aluminum tape and intentionally causing a reflection signal from the aluminum tape to appear on underground data, arrangement of underground data of each measuring line may be performed. However, in an environment where it is not possible to restrict vehicles and the like other than those involved in the inspection from entering the inspection range, the work of attaching and removing the aluminum tape is dangerous depending on the traffic condition.

Furthermore, in some cases, arrangement of underground data is performed by using, instead of the aluminum tape, a metal structure on a pavement surface, such as a manhole or a grating, as a mark. Then, in order to arrange underground data for each measuring line, it is necessary to measure a common metal structure by superimposing the metal structure on all the measuring lines. However an appropriate metal structure as a mark is not always present in the inspection range, and the metal structure cannot be used as a reference for arrangement in some cases. In addition, a measurement width of the radar when acquiring underground data is often equal to or narrower than a vehicle width, and it takes time and effort to perform measurement by superimposing marks on a plurality of measuring lines at the time of measurement. As a result, it is difficult to use the same target as a reference.

Recently, a technique of mapping underground data to position information by linking the position information measured by a global navigation satellite system (GNSS) with the underground data has become common. That is, a movement trajectory of the GPR device is obtained based on GNSS data simultaneously acquired at the time of acquiring GPR data, and the movement trajectory is associated as a measuring line. However, in a case where an environment (position) of the GNSS satellite is poor or in an environment where multipath occurs, position information with high accuracy cannot be obtained, and a deviation may occur in a case where arrangement of underground data of a plurality of measuring lines is performed using the movement trajectory obtained by the GNSS as a measuring line.

There is also a method in which a prism is attached to a GPR device and position information of the GPR device is acquired by a total station fixed on the ground. However, in this method, there are many restrictions that an inspection range is limited to a range in which the total station can be installed, that the total station can be used only in an environment without an obstacle, and the like.

In addition, a method of performing arrangement between a plurality of measuring lines by using a simultaneous localization and mapping (SLAM) technique using light detection and ranging (LiDAR) or by using a self-localization estimation result obtained by visual SLAM (VSLAM) using a high-resolution camera is also conceivable. However, the accuracy is not yet practical, and the accuracy may depend on the presence or absence and the number of feature points of a detected object required for SLAM processing.

Further, it is also conceivable to arrange the underground data for each measuring line by using, as a clue, structure information indicated by the underground data, such as pipe information. However, interpretation of whether or not the underground data actually represents a structure such as a pipe having continuity depends on experience and skills of an analyst, and reliability cannot be secured.

For this reason, a technique of acquiring a road surface image together with underground data and performing arrangement of the underground data based on the road surface image has been proposed.

For example, there has been proposed an underground exploration method in which a plurality of underground radar sensors are provided along a vehicle width direction or an underground radar sensor is provided to be able to move in a vehicle width direction, an image of a road surface separated from the underground radar sensor by a predetermined distance is captured with a width wider than an exploration width of the underground radar sensor, an exploration vehicle provided with road surface image capturing means in which a captured road surface image and travel information are to be recorded is caused to travel a plurality of times while changing lanes, exploration information for each lane is obtained by projecting radar waves from the underground radar sensor on the road surface and receiving reflected waves, a road surface image of a traveling road surface for each lane is obtained by the road surface image capturing means, and then exploration of a range under the road surface is performed by synthesizing the exploration information for each lane with reference to the road surface image (refer to Japanese Patent No. 3936472).

In addition, for example, there has been proposed an underground radar system that includes an underground radar device which includes a traveling unit for self-traveling and performs underground exploration of a target area and a control device that controls traveling of the underground radar device based on image data obtained by capturing the target area from above (refer to Japanese Patent Application Laid-Open (JP-A) No. 2024-3679).

Further, for example, there has been proposed an underground exploration device including an exploration vehicle that is a vehicle including a plurality of wheels including a front wheel and a rear wheel and configured to travel on a road surface, underground exploration means that is provided in the exploration vehicle and generates three-dimensional information of an underground range under the road surface on which the exploration vehicle travels, overground video generation means that is provided in the exploration vehicle and generates a three-dimensional overground video of the road surface on which the exploration vehicle travels, and three-dimensional information integration processing means that generates integrated three-dimensional information from an underground space to an overground space by performing predetermined data integration processing on the three-dimensional underground information generated by the underground exploration means and the three-dimensional overground video generated by the overground video generation means, in which the underground exploration means is provided between the front wheel and the rear wheel or between axles of the plurality of wheels on a bottom surface of the exploration vehicle, the overground video generation means generates an overground orthographic image by converting the three-dimensional overground video of the road surface on which the exploration vehicle travels into an orthographic projection image viewed from directly above, and the three-dimensional information integration processing means generates an integrated processing image in which the three-dimensional underground information is integrally displayed on the overground orthographic image (refer to Japanese Patent No. 6446005).

### SUMMARY

In a case where the inspection range extends over a long distance, when performing arrangement of underground data acquired along a plurality of measuring lines, a deviation in arrangement may be accumulated, or it may be difficult to optimize arrangement to achieve overall consistency.

The present disclosure has been made in view of the above points, and an object of the present disclosure is to provide an underground data management device, an underground data management method, and an underground data management program capable of accurately arranging underground data acquired along a plurality of measuring lines even in a case where an inspection range extends over a long distance.

In order to achieve the above object, according to the present disclosure, there is provided an underground data management device including: an acquisition unit that acquires an image obtained by capturing a road surface and underground data based on an intensity of reflected waves of electromagnetic waves emitted in a direction from the road surface toward an underground space, in association with acquisition positions of the image and the underground data along a plurality of measuring lines which are set such that capturing ranges of the images partially overlap; a specifying unit that selects a reference measuring line from the plurality of measuring lines, divides the image corresponding to each of the plurality of measuring lines into a plurality of blocks along the measuring line, and specifies, for each block, a relative position of each of the other measuring lines with respect to the reference measuring line by associating the block of the image corresponding to the reference measuring line and the block of the image corresponding to each of the other measuring lines such that feature points in the images match each other; and a management unit that manages, for each block, a position of the reference measuring line and the acquisition positions of the image and the underground data which are acquired along the reference measuring line in association with each other, and manages, for each block, a position of each of the other measuring lines which is specified from the relative position with respect to the reference measuring line and the acquisition positions of the image and the underground data which are acquired along each of the other measuring lines in association with each other.

Further, according to the present disclosure, there is provided an underground data management method executed by an underground data management device including an acquisition unit, a specifying unit, and a management unit, the method comprising: causing the acquisition unit to acquire an image obtained by capturing a road surface and underground data based on an intensity of reflected waves of electromagnetic waves emitted in a direction from the road surface toward an underground space, in association with acquisition positions of the image and the underground data along a plurality of measuring lines which are set such that capturing ranges of the images partially overlap; causing the specifying unit to select a reference measuring line from the plurality of measuring lines, divide the image corresponding to each of the plurality of measuring lines into a plurality of blocks along the measuring line, and specify, for each block, a relative position of each of the other measuring lines with respect to the reference measuring line by associating the block of the image corresponding to the reference measuring line and the block of the image corresponding to each of the other measuring lines such that feature points in the images match each other; and causing the management unit to manage, for each block, a position of the reference measuring line and the acquisition positions of the image and the underground data which are acquired along the reference measuring line in association with each other, and manage, for each block, a position of each of the other measuring lines which is specified from the relative position with respect to the reference measuring line and the acquisition positions of the image and the underground data which are acquired along each of the other measuring lines in association with each other.

Further, according to the present disclosure, there is provided an underground data management program for causing a computer to function as: an acquisition unit that acquires an image obtained by capturing a road surface and underground data based on an intensity of reflected waves of electromagnetic waves emitted in a direction from the road surface toward an underground space, in association with acquisition positions of the image and the underground data along a plurality of measuring lines which are set such that capturing ranges of the images partially overlap; a specifying unit that selects a reference measuring line from the plurality of measuring lines, divides the image corresponding to each of the plurality of measuring lines into a plurality of blocks along the measuring line, and specifies, for each block, a relative position of each of the other measuring lines with respect to the reference measuring line by associating the block of the image corresponding to the reference measuring line and the block of the image corresponding to each of the other measuring lines such that feature points in the images match each other; and a management unit that manages, for each block, a position of the reference measuring line and the acquisition positions of the image and the underground data which are acquired along the reference measuring line in association with each other, and manages, for each block, a position of each of the other measuring lines which is specified from the relative position with respect to the reference measuring line and the acquisition positions of the image and the underground data which are acquired along each of the other measuring lines in association with each other.

According to the underground data management device, the underground data management method, and the underground data management program according to the present disclosure, it is possible to accurately arrange the underground data acquired along the plurality of measuring lines even in a case where the inspection range extends over a long distance.

### BRIEF DESCRIPTION OF THE DRAWINGS

FIG. 1 is a schematic configuration diagram of an underground data management system;

FIG. 2 is a diagram for explaining generation of a road surface image;

FIG. 3 is a diagram for explaining generation of underground data;

FIG. 4 is a block diagram illustrating a hardware configuration of an underground data management device;

FIG. 5 is a block diagram illustrating an example of a functional configuration of the underground data management device;

FIG. 6 is a diagram illustrating an example of division of an inspection range;

FIG. 7 is a diagram for explaining selection of a reference measuring line;

FIG. 8 is a diagram for explaining division of a road surface image;

FIG. 9 is a diagram for explaining specifying a relative position of each of the other measuring lines with respect to a reference measuring line;

FIG. 10 is a diagram for explaining a portion of a road surface image that is not used for matching;

FIG. 11 is a diagram for explaining arrangement of underground data based on a relative position with respect to a reference measuring line;

FIG. 12 is a diagram for explaining management using a relative position of a feature point of underground data;

FIG. 13 is a flowchart illustrating a flow of underground data management processing;

FIG. 14 is a diagram for explaining another example of selection of a reference measuring line; and

FIG. 15 is a diagram for explaining correction of a reference measuring line.

### DETAILED DESCRIPTION OF THE INVENTION

Hereinafter, an example of an embodiment of the present disclosure will be described with reference to the drawings. In the drawings, the same or equivalent components and portions are denoted by the same reference numerals. In addition, dimensions and ratios in the drawings are exaggerated for convenience of description, and may be different from actual ratios.

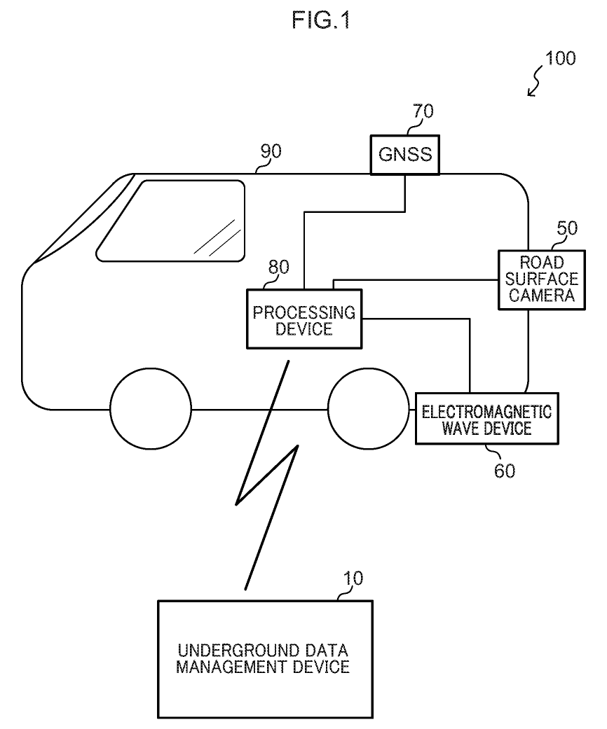

FIG. 1 is a diagram illustrating a schematic configuration of an underground data management system 100 according to the present embodiment. The underground data management system 100 includes a road surface camera 50, an electromagnetic wave device 60, a GNSS 70, and a processing device 80 that are mounted on a vehicle 90, and an underground data management device 10 that is provided in a predetermined facility such as a company.

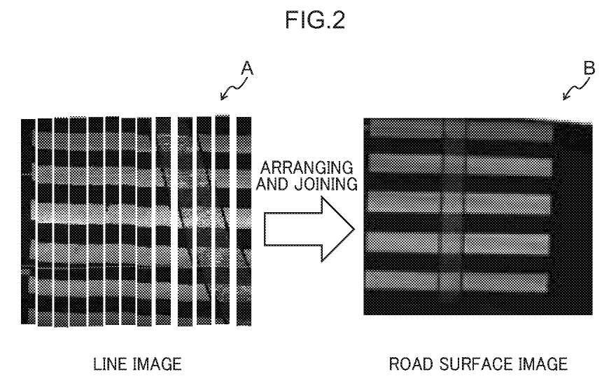

The road surface camera 50 is, for example, a line scan camera, and includes a plurality of light receiving units on a line orthogonal to a movement direction of the vehicle 90. The road surface camera 50 captures a line image as illustrated in A of FIG. 2 at each position along each of a plurality of measuring lines which cover the entire inspection range and are set such that image capturing ranges partially overlap each other. The road surface camera 50 outputs the captured line image to the processing device 80.

The road surface camera 50 is not limited to a line scan camera, may be a general two-dimensional camera, or may be a color camera, a black-and-white camera, or a camera that detects reflectance of light having a specific wavelength, such as an infrared camera. A type of the road surface camera is not limited.

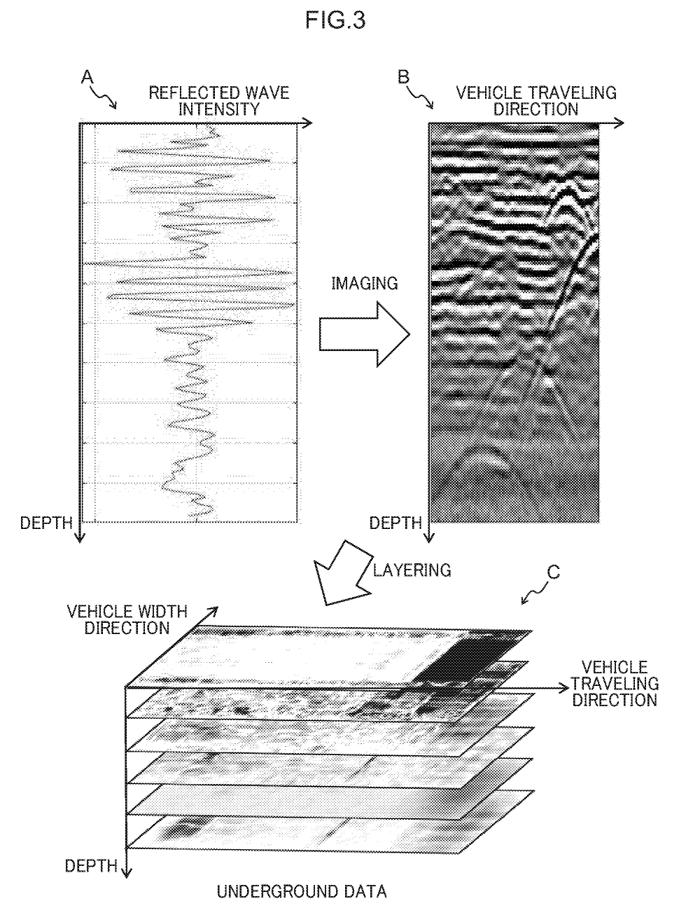

The electromagnetic wave device 60 includes a plurality of electromagnetic wave irradiation units and a plurality of receiving units on a line orthogonal to the movement direction of the vehicle 90. The electromagnetic wave device 60 irradiates the inspection range with electromagnetic waves in a direction from the road surface toward an underground space (depth direction) at each position along each of the plurality of measuring lines, and receives reflected waves of the electromagnetic waves. Thereby, a reflected wave intensity corresponding to the depth is detected for each grid in the inspection range. The depth corresponds to a time from the irradiation of the electromagnetic waves to the reception of the reflected waves. The reflected wave intensity corresponding to the depth is detected for one grid in a form of a reflection response waveform as illustrated in A of FIG. 3. The electromagnetic wave device 60 outputs the reflection response waveform for each grid that is detected along the plurality of measuring lines to the processing device 80.

The GNSS 70 measures position information (latitude and longitude) of the vehicle 90 at predetermined sampling intervals, and outputs the measured position information to the processing device 80.

The processing device 80 calculates a movement trajectory of the vehicle 90 from the position information which is output from the GNSS 70. The movement trajectory of the vehicle 90 corresponds to a measuring line. The processing device 80 associates the line image of each line that is captured by the road surface camera 50 and the reflection response waveform of each line that is detected by the electromagnetic wave device 60 with each point on the movement trajectory according to an acquisition timing.

Further, as illustrated in B of FIG. 2, the processing device 80 generates a road surface image by arranging and joining the line images output from the road surface camera 50 along the measuring lines in the vehicle traveling direction.

In addition, the processing device 80 generates underground data from the reflection response waveform that is output from the electromagnetic wave device 60. Specifically, the processing device 80 replaces the reflected wave intensity of each grid with a pixel value (shading of black and white) for each depth, and arranges the pixel values along the measuring lines in the vehicle traveling direction as illustrated in B of FIG. 3. Further, the processing device 80 generates a planar image for each depth by extracting a pixel value corresponding to each desired depth of each grid. As illustrated in C of FIG. 3, the processing device 80 generates three-dimensional underground data by layering the planar images for each depth.

The processing device 80 transmits the generated road surface image, the generated underground data, and the movement trajectory (measuring lines) to the underground data management device 10. In a case where the inspection range is measured along each of the plurality of measuring lines, the road surface image and the underground data for each measuring line are transmitted. Each data is not limited to as being transmitted from the processing device 80, and may be stored in a storage medium and read into the underground data management device 10. The underground data management device 10 itself may be mounted on the vehicle 90, and each data may be directly input to the underground data management device 10.

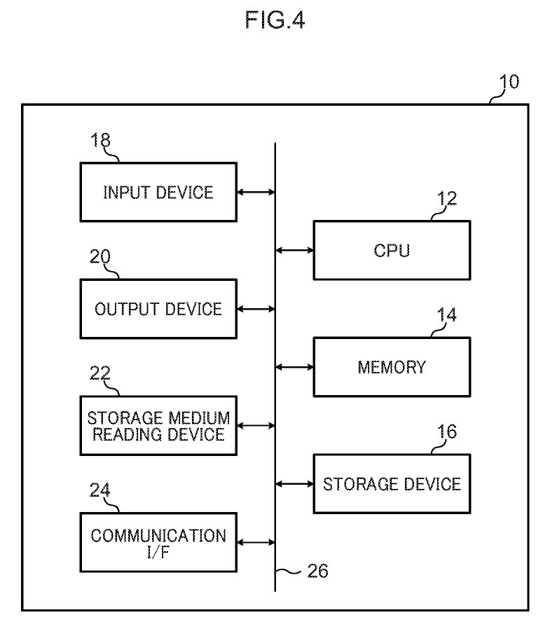

The underground data management device 10 is an information processing device such as a personal computer or a tablet terminal. FIG. 4 is a block diagram illustrating a hardware configuration of the underground data management device 10 according to the present embodiment. As illustrated in FIG. 4, the underground data management device 10 includes a central processing unit (CPU) 12, a memory 14, a storage device 16, an input device 18, an output device 20, a storage medium reading device 22, and a communication interface (I/F) 24. The respective components are communicably connected to each other via a bus 26.

The storage device 16 stores an underground data management program for executing underground data management processing to be described later. The CPU 12 is a central processing unit, and executes various programs and controls each component. That is, the CPU 12 reads the program from the storage device 16, and executes the program by using the memory 14 as a work area. The CPU 12 controls the components and performs various arithmetic processing according to the program stored in the storage device 16.

The memory 14 includes a random access memory (RAM), and temporarily stores a program and data as a work area. The storage device 16 includes a read only memory (ROM), a hard disk drive (HDD), a solid state drive (SSD), or the like, and stores various programs including an operating system and various data.

The input device 18 is, for example, a device for receiving various types of input, such as a keyboard and a mouse. The output device 20 is, for example, a device for outputting various types of information, such as a display and a printer. In a case of adopting a touch panel display as the output device 20, the touch panel display may function as the input device 18.

The storage medium reading device 22 reads data stored in various types of storage medium such as a compact disc (CD)-ROM, a digital versatile disc (DVD)-ROM, a Blu-ray disc, or a Universal Serial Bus (USB) memory, and writes data in the storage medium. The communication I/F 24 is an interface that performs communication with other devices, and performs communication by using, for example, a standard such as Ethernet (registered trademark), FDDI, or Wi-Fi (registered trademark).

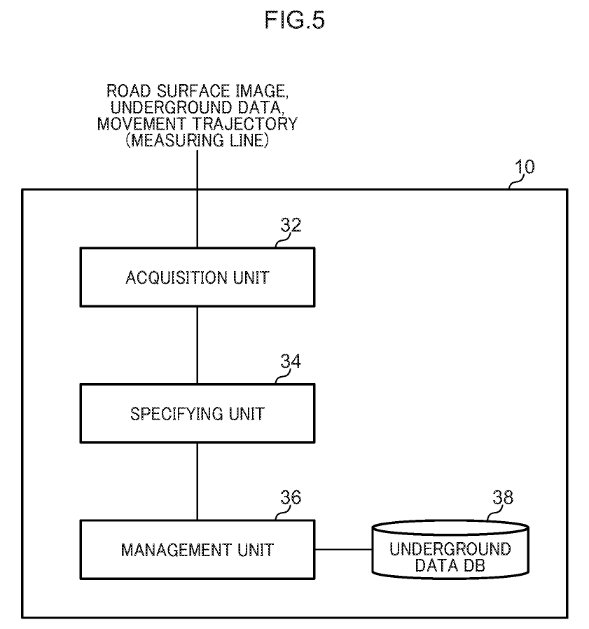

Next, a functional configuration of the underground data management device 10 according to the present embodiment will be described. FIG. 5 is a block diagram illustrating an example of a functional configuration of the underground data management device 10. As illustrated in FIG. 5, the underground data management device 10 includes an acquisition unit 32, a specifying unit 34, and a management unit 36 as functional components. Further, in a predetermined storage area of the underground data management device 10, an underground data DB 38 is stored. The functional components are implemented by causing the CPU 12 to read an underground data management program stored in the storage device 16, develop the underground data management program in the memory 14, and execute the underground data management program.

The acquisition unit 32 acquires the road surface image and the underground data for each measuring line and the movement trajectory (measuring line), which are transmitted from the processing device 80. As described above, the road surface image for each measuring line is captured such that the imaging ranges partially overlap. In addition, acquisition positions of the road surface image and the underground data are associated with the measuring line. The acquisition unit 32 transmits the acquired data to the specifying unit 34.

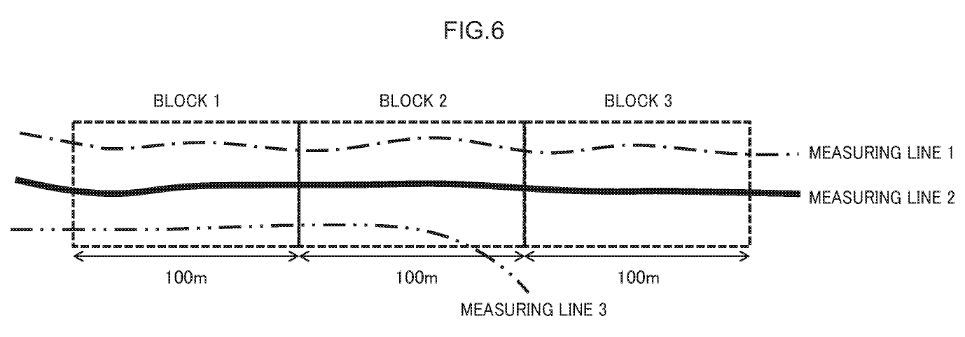

The specifying unit 34 divides the inspection range into a plurality of blocks. FIG. 6 illustrates an example of division. In the example of FIG. 6, the inspection range is divided into blocks at predetermined distances (in the example of FIG. 6, every 100 m) along an extending direction of the measuring line.

In addition, the specifying unit 34 selects a reference measuring line from the plurality of measuring lines. Specifically, the specifying unit 34 selects, as a reference measuring line, a measuring line closest to the center, a measuring line closest to a straight line, or a measuring line on which the position information can be acquired most stably, among the plurality of measuring lines. For example, in the example of FIG. 6, the specifying unit 34 may select, as the reference measuring line, the measuring line 2 which is the middle measuring line from among the measuring line 1, the measuring line 2, and the measuring line 3. The specifying unit 34 may exclude the measuring line 3 that does not pass through the block 3, and may select the measuring line 2 as the reference measuring line based on a fact that the measuring line 2 is a measuring line closer to a straight line. For example, whether or not the measuring line is close to a straight line may be determined by a magnitude of an error between each measuring line and an approximate straight line of the measuring line.

In addition, the specifying unit 34 may determine the measuring line on which the position information can be acquired most stably based on at least one of a reception intensity of radio waves from a satellite in the GNSS 70, a change in the moving speed of the vehicle 90, and a change in the traveling direction of the vehicle 90. For example, the specifying unit 34 may calculate an average of reception intensities of radio waves for each measuring line, and select a measuring line having the highest average as the reference measuring line.

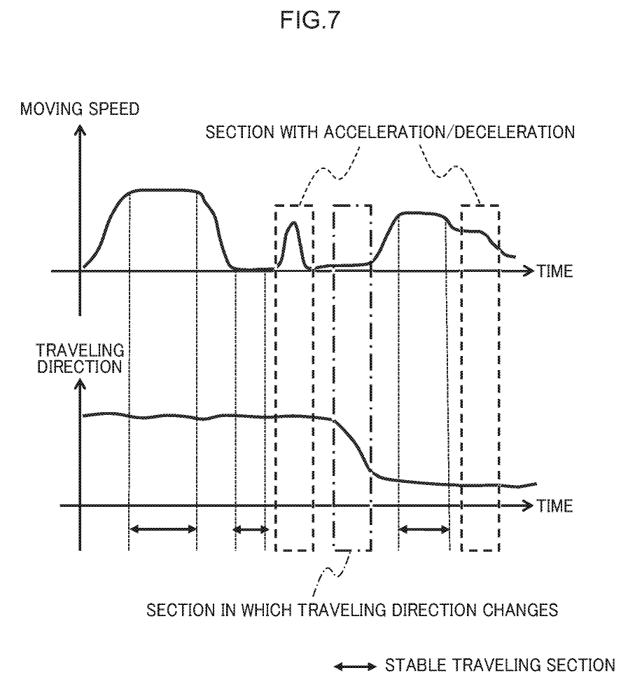

For example, as illustrated in FIG. 7, it is assumed that the moving speed and the traveling direction of the vehicle 90 are obtained. The moving speed and the traveling direction may be calculated from the movement trajectory, or may be acquired from a vehicle speed sensor and a gyro sensor (not illustrated) provided in the vehicle 90. The specifying unit 34 specifies a section in which a change in the moving speed is equal to or larger than a predetermined value as a section with acceleration/deceleration (in FIG. 7, a section in a broken line frame), specifies a section in which a change in the traveling direction is equal to or larger than a predetermined value as a section in which the traveling direction changes (in FIG. 7, a section in a one-dotted chain line frame), and specifies other sections as stable traveling sections. The specifying unit 34 may specify stable traveling sections for each of the measuring lines, and select a measuring line in which the stable traveling section is longest as the reference measuring line.

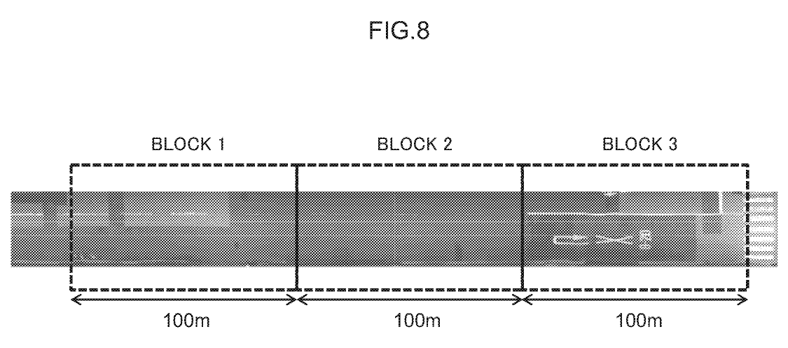

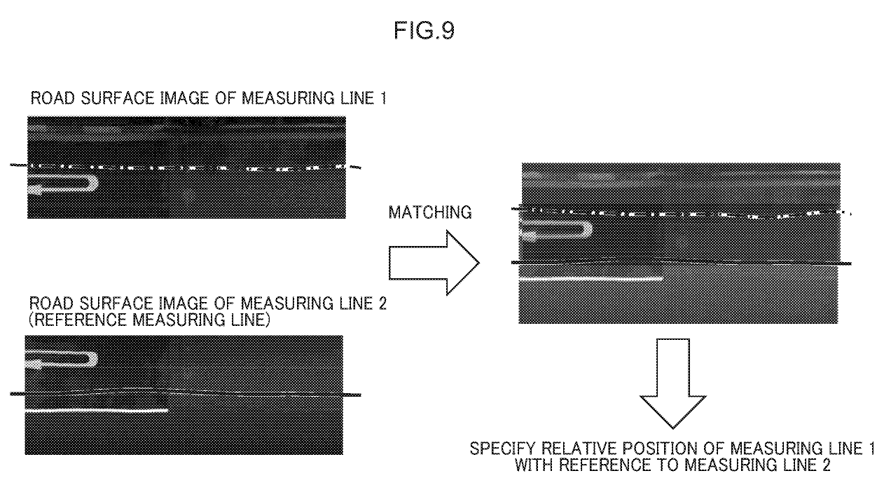

Further, as illustrated in FIG. 8, the specifying unit 34 specifies a relative position of each of the other measuring lines with respect to the reference measuring line for each block by using a portion of the road surface image, the portion corresponding to each of the plurality of measuring lines and corresponding to each divided block of the road surface image. Specifically, as illustrated in FIG. 9, the specifying unit 34 associates a block of the road surface image that corresponds to the reference measuring line with a block of the road surface image that corresponds to each of the other measuring lines such that feature points in the images match each other. The specifying unit 34 deforms a road surface image of each of the other measuring lines by, for example, affine transformation or the like so as to match the road surface image with a road surface image of the reference measuring line, and also deforms each of the other measuring lines in accordance with the deformation of the road surface image of each of the other measuring lines. Thereby, the specifying unit 34 specifies a relative position of each of the other measuring lines with reference to the reference measuring line. The example of FIG. 9 illustrates a case where the measuring line 2 is set as a reference measuring line, and illustrates a case where a relative position of the measuring line 1 with reference to the measuring line 2 is specified by matching a U-turn mark included in an overlapping region between the road surface image of the measuring line 1 and the road surface image of the measuring line 2.

The matching processing between the road surface image of the reference measuring line and the road surface image of each of the other measuring lines is not limited to a case where the matching processing is automatically performed using an image matching technique. The matching processing may be manually performed by a person, or a result obtained by automatically performing the matching processing may be manually corrected by a person. In addition, the matching processing is not limited to a case where the matching processing is performed such that the road surface image of the reference measuring line and the road surface image of each of the other measuring lines completely match with each other. The matching processing may be performed such that a deviation amount is minimized as a whole using a least squares method or the like.

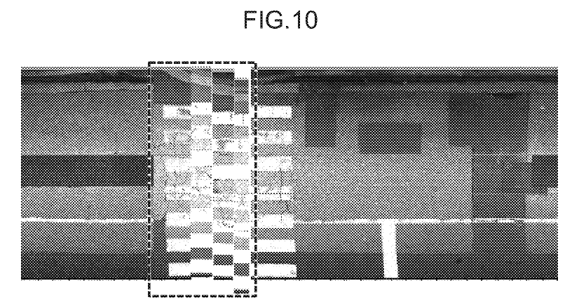

In addition, when performing matching of the road surface image, the specifying unit 34 may not use, for the matching, a portion of the road surface image that is not acquired with predetermined accuracy, such as a portion of the road surface image in which the image is distorted due to vibration of the vehicle 90 or the like. Specifically, the specifying unit 34 regards a portion where a variation in the movement trajectory is equal to or larger than a predetermined value or a portion where a variation in the output of the speed sensor, the gyro sensor, or the like is equal to or larger than a predetermined value, as a portion where a vibration has occurred, and marks the portion on the road surface image (in FIG. 10, a broken line frame) as illustrated in FIG. 10. Then, the specifying unit 34 does not select a feature point when performing matching of the road surface image, from the marked portion.

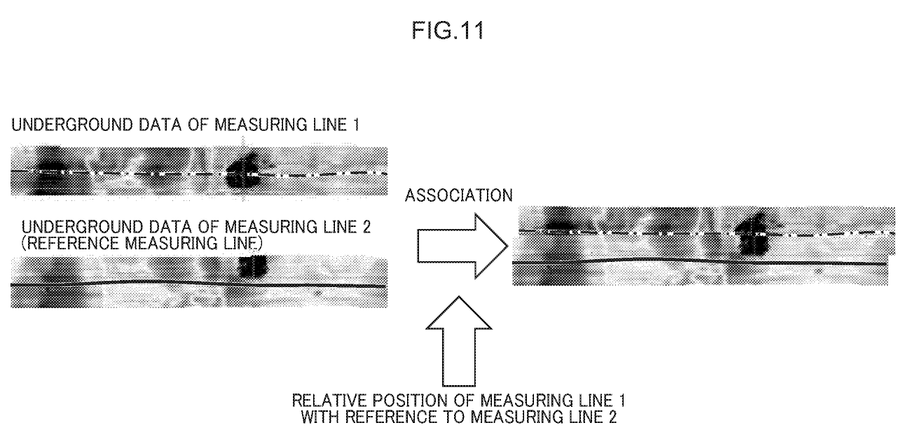

The management unit 36 stores, for each block, the position of the reference measuring line and the acquisition positions of the road surface image and the underground data that are acquired along the reference measuring line in the underground data DB 38 in association with each other. In addition, the management unit 36 stores, in the underground data DB 38, the position of each of the other measuring lines that is specified from the relative position with respect to the reference measuring line, and the acquisition positions of the road surface image and the underground data that are acquired along each of the other measuring lines, in association with each other. Thereby, as illustrated in FIG. 11, the underground data of the reference measuring line and the underground data of each of the other measuring lines are arranged in association with each other based on a specified relative positional relationship. The example of FIG. 11 illustrates a case where the underground data of the measuring line 1 which is one of the other measuring lines is deformed based on the relative position of the measuring line 1 with reference to the measuring line 2 which is a reference measuring line and is then arranged with the underground data of the measuring line 1.

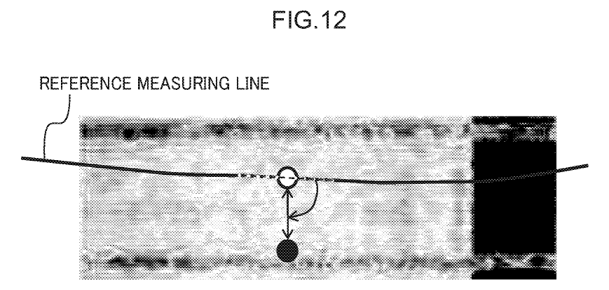

Further, the management unit 36 may manage the position of the feature point in the underground data by using the relative position with respect to the reference measuring line. For example, as illustrated in FIG. 12, the position of the feature point (in FIG. 12, a black circle) of the underground data may be managed by using a distance from an origin (in FIG. 12, a white circle) determined at an arbitrary position on the reference measuring line and an azimuth (angle) with respect to a tangential direction at the origin of the reference measuring line.

Next, an operation of the underground data management system 100 according to the present embodiment will be described.

While the vehicle 90 is traveling, imaging by the road surface camera 50, detection by the electromagnetic wave device 60, and position measurement by the GNSS 70 are started. Then, the line image captured by the road surface camera 50, the reflection response waveform detected by the electromagnetic wave device 60, and the position information measured by the GNSS 70 are output to the processing device 80. The processing device 80 generates underground data from the reflection response waveform, generates a road surface image from the line image, generates a movement trajectory (measuring line) from the position information, and transmits the underground data, the road surface image, and the movement trajectory to the underground data management device 10.

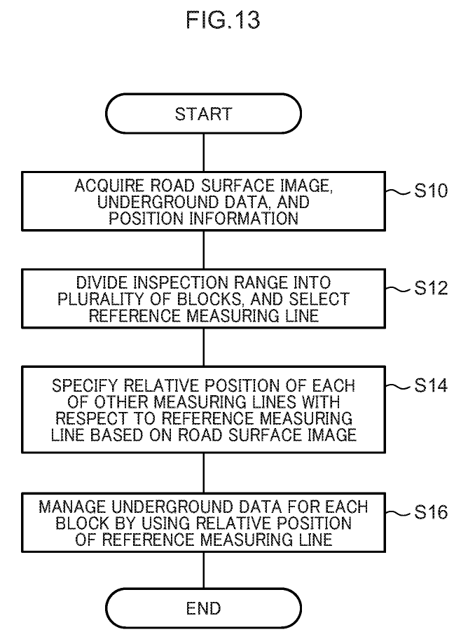

In the underground data management device 10, underground data management processing is executed. FIG. 13 is a flowchart illustrating a flow of underground data management processing executed by the CPU 12 of the underground data management device 10. The CPU 12 reads the underground data management program from the storage device 16, develops the program in the memory 14, and executes the program. Thereby, the CPU 12 functions as each functional component of the underground data management device 10, and the underground data management processing illustrated in FIG. 13 is executed. The underground data management processing is an example of an underground data management method according to the present disclosure.

First, in step S10, the acquisition unit 32 acquires the road surface image and the underground data for each measuring line and the movement trajectory (measuring line) that are transmitted from the processing device 80. Next, in step S12, the specifying unit 34 divides the inspection range into a plurality of blocks. Then, the specifying unit 34 selects, from the plurality of measuring lines, for example, a measuring line closest to the center, a measuring line closest to a straight line, or a measuring line on which the position information can be acquired most stably, as a reference measuring line.

Next, in step S14, the specifying unit 34 associates, for each block, the block of the road surface image corresponding to the reference measuring line and the block of the road surface image corresponding to each of the other measuring lines such that the feature points in the images match each other. Then, the specifying unit 34 specifies a relative position of each of the other measuring lines with reference to the reference measuring line by deforming the road surface image of each of the other measuring lines by, for example, affine transformation or the like such that the road surface image of each of the other measuring lines matches the road surface image of the reference measuring line, and also deforming each of the other measuring lines in accordance with the deformation of the road surface image of each of the other measuring lines.

Next, in step S16, the management unit 36 stores, for each block, the position of the reference measuring line and the acquisition positions of the road surface image and the underground data that are acquired along the reference measuring line in the underground data DB 38 in association with each other. In addition, the management unit 36 stores, in the underground data DB 38, the position of each of the other measuring lines that is specified from the relative position with respect to the reference measuring line, and the acquisition positions of the road surface image and the underground data that are acquired along each of the other measuring lines in association with each other. Thereby, the underground data is managed for each block by using the relative position with reference to the reference measuring line, and the underground data management processing is ended.

As described above, according to the underground data management system according to the present embodiment, the underground data management device acquires the road surface image and the underground data along the plurality of measuring lines which are set such that imaging ranges of the road surface images partially overlap with each other, in association with the acquisition positions of the road surface image and the underground data. In addition, the underground data management device selects the reference measuring line from the plurality of measuring lines, and divides the road surface image corresponding to each of the plurality of measuring lines into a plurality of blocks along the measuring line. Further, the underground data management device specifies, for each block, the relative position of each of the other measuring lines with respect to the reference measuring line by associating the block of the image corresponding to the reference measuring line with the block of the image corresponding to each of the other measuring lines such that the feature points in the images match each other. Then, the underground data management device manages, for each block, the position of the reference measuring line and the acquisition positions of the image and the underground data that are acquired along the reference measuring line in association with each other. Further, the underground data management device manages the position of each of the other measuring lines that is specified from the relative position with respect to the reference measuring line and the acquisition positions of the image and the underground data that are acquired along each of the other measuring lines in association with each other. Thereby, even in a case where the inspection range extends over a long distance, it is possible to accurately arrange the underground data acquired along the plurality of measuring lines.

That is, the underground data management device according to the present embodiment selects the reference measuring line from the plurality of measuring lines, divides the inspection range into the plurality of blocks, and manages the underground data by using the relative position with respect to the reference measuring line. Thereby, as compared with a case where the underground data over a long distance is arranged without being divided into blocks, it is possible to prevent a deviation in arrangement of the underground data for each measuring line and perform arrangement with high accuracy.

In the present embodiment, since arrangement of the underground data is performed for each block, some misarrangement may occur between the blocks. However, for example, in a case where the underground data managed by the underground data management device according to the present embodiment is referred to when performing probing or the like of a road, the underground data of the block including a position of a probing target is referred to. Thus, the misarrangement between the blocks does not become a big problem. The arrangement between the blocks may be corrected based on information such as a buried pipe appearing in the underground data.

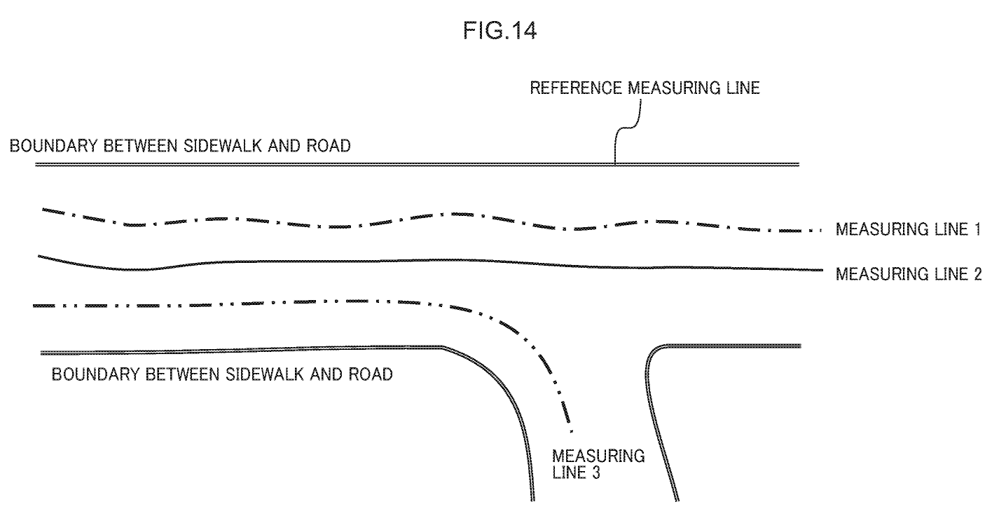

In the above embodiment, the case where the movement trajectory of the vehicle that is generated from the position information measured by the GNSS is used as the measuring line has been described, but the present embodiment is not limited thereto. For example, a movement trajectory estimated by self-position estimation such as SLAM or VSLAM, or a movement trajectory that is specified based on accumulation of measurement values of an inertial measurement device may be used as the measuring line. Further, as illustrated in FIG. 14, in the inspection range, information that can be a reference measuring line, for example, a boundary between a sidewalk and a road, a lane, and the like may be detected from the road surface image, and the detected information may be used as the reference measuring line.

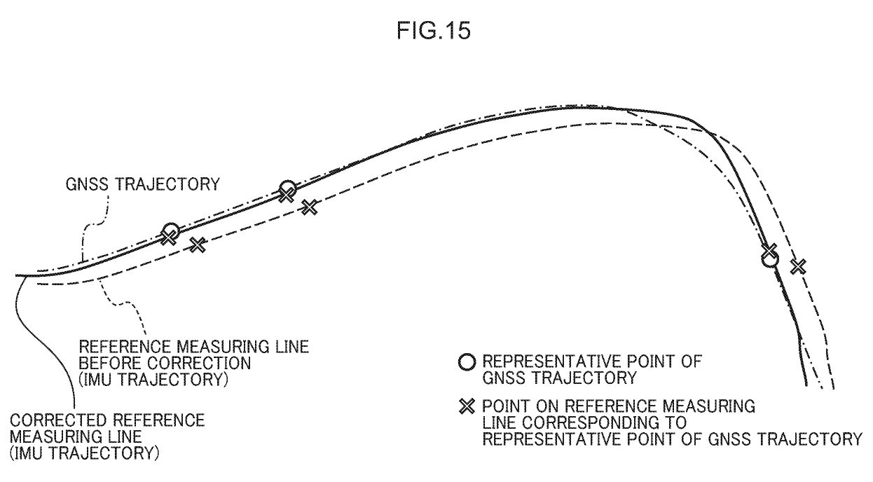

Here, in the case of the movement trajectory (hereinafter, referred to as “GNSS trajectory”) generated from the position information measured by GNSS, there may be a position at which the accuracy is reduced due to an arrangement situation of satellites and an influence of multipath. In addition, in the case of the movement trajectory (hereinafter, referred to as “IMU trajectory”) specified based on accumulation of measurement values of an inertial measurement device, errors at respective positions are accumulated, and a deviation from the actual movement trajectory increases as the movement trajectory becomes longer. In this case, as illustrated in FIG. 15, the IMU trajectory may be acquired as a measuring line, and the IMU trajectory before correction indicating a selected reference measuring line may be corrected such that a position of a corresponding point on the IMU trajectory matches a position of a representative point on the GNSS trajectory. The representative point on the GNSS trajectory may be, for example, a position measurement point at which a reception intensity of radio waves from the satellite is equal to or higher than a predetermined value, or a position measurement point in the stable traveling section described in FIG. 7. In addition, as a correction method, processing of matching, to a representative point on the GNSS trajectory, a point on the IMU trajectory corresponding to the representative point and performing pose adjustment by a least-square method with constraints or the like such that a pitch of the IMU trajectory does not greatly change, which is equivalent to the so-called SLAM loop closure, may be performed.

In the above embodiment, the case where the road surface camera, the electromagnetic wave device, and the GNSS are mounted on the vehicle has been described, but the present disclosure is not limited thereto. For example, these devices may be mounted on a hand push type cart.

Further, a part of the processing of the processing device in the above embodiment may be executed by the underground data management device. For example, the line image captured by the road surface camera, the reflection response waveform detected by the electromagnetic wave device, and the position information measured by GNSS may be transmitted to the underground data management device, and the underground data management device may generate a road surface image, underground data, and a movement trajectory for each measuring line.

In the above embodiment, the case where the buried pipe or the like under the road surface is inspected as the underground data has been described as an example, but the present disclosure is not limited thereto. For example, the technique of the present disclosure can also be applied to deterioration diagnosis inspection of a bridge, a pavement, and the like, depression prevention inspection for inspecting a cavity or the like under a road surface, and the like.

In addition, various processors other than the CPU may execute the underground data management processing executed by causing the CPU to read the software (program) in the above embodiment. Examples of the processor in this case include a programmable logic device (PLD) such as a field-programmable gate array (FPGA) in which a circuit configuration can be changed after manufacturing, a dedicated electric circuit such as an application specific integrated circuit (ASIC) that is a processor having a circuit configuration exclusively designed for executing specific processing, and the like. Further, the underground data management processing may be executed by one of these various processors, or may be executed by a combination of two or more processors of the same type or different types (for example, a plurality of FPGAs, a combination of a CPU and an FPGA, and the like). Further, a hardware structure of these various processors is, more specifically, an electric circuit in which circuit elements such as semiconductor elements are combined.

Furthermore, in the above embodiment, the form in which the underground data management program is stored (installed) in the storage device in advance has been described, but the present disclosure is not limited thereto. The program may be provided in a form of being recorded in a recording medium such as a CD-ROM, a DVD-ROM, or a USB memory. In addition, the program may be downloaded from an external device via a network.

### DESCRIPTION OF REFERENCE NUMERALS

10 UNDERGROUND DATA MANAGEMENT DEVICE

12 CPU

14 MEMORY

16 STORAGE DEVICE

18 INPUT DEVICE

20 OUTPUT DEVICE

22 STORAGE MEDIUM READING DEVICE

24 COMMUNICATION I/F

26 BUS

32 ACQUISITION UNIT

34 SPECIFYING UNIT

36 MANAGEMENT UNIT

38 UNDERGROUND DATA DB

50 ROAD SURFACE CAMERA

60 ELECTROMAGNETIC WAVE DEVICE

80 PROCESSING DEVICE

90 VEHICLE

100 UNDERGROUND DATA MANAGEMENT SYSTEM

What is claimed is:

1. An underground data management device comprising:
one or more processors, wherein
the one or more processors are configured to:
acquire an image obtained by capturing a road surface and underground data based on an intensity of reflected waves of electromagnetic waves emitted in a direction from the road surface toward an underground space, in association with acquisition positions of the image and the underground data along a plurality of measuring lines which are set such that capturing ranges of the images partially overlap;
select a reference measuring line from the plurality of measuring lines, divide the image corresponding to each of the plurality of measuring lines into a plurality of blocks along the measuring line, and specify, for each block, a relative position of each of the other measuring lines with respect to the reference measuring line by associating the block of the image corresponding to the reference measuring line and the block of the image corresponding to each of the other measuring lines such that feature points in the images match each other; and
manage, for each block, a position of the reference measuring line and the acquisition positions of the image and the underground data which are acquired along the reference measuring line in association with each other, and manage, for each block, a position of each of the other measuring lines which is specified from the relative position with respect to the reference measuring line and the acquisition positions of the image and the underground data which are acquired along each of the other measuring lines in association with each other.

2. The underground data management device according to claim 1, wherein
among the plurality of measuring lines, a measuring line closest to a center, a measuring line closest to a straight line, or a measuring line on which the acquisition position is acquired most stably is selected as the reference measuring line.

3. The underground data management device according to claim 2, wherein
the measuring line on which the acquisition position is acquired most stably is determined based on at least one of a reception intensity of radio waves from a satellite in a case where the acquisition position is measured by GNSS, a change in a moving speed of a system that acquires the underground data, or a change in a traveling direction of the system.

4. The underground data management device according to claim 1, wherein
a portion of the image that is not acquired with predetermined accuracy is excluded from the feature points in the images when associating the block of the image corresponding to the reference measuring line and the block of the image corresponding to each of the other measuring lines.

5. The underground data management device according to claim 2, wherein
a portion of the image that is not acquired with predetermined accuracy is excluded from the feature points in the images when associating the block of the image corresponding to the reference measuring line and the block of the image corresponding to each of the other measuring lines.

6. The underground data management device according to claim 3, wherein
a portion of the image that is not acquired with predetermined accuracy is excluded from the feature points in the images when associating the block of the image corresponding to the reference measuring line and the block of the image corresponding to each of the other measuring lines.

7. The underground data management device according to claim 1, wherein
a trajectory of the acquisition positions of the image and the underground data is acquired as the measuring line, the trajectory being specified based on accumulation of measurement values of an inertial measurement device, and
the trajectory indicating the reference measuring line is corrected such that a corresponding position on the trajectory matches with a position measured by GNSS with accuracy equal to or higher than a reference value.

8. The underground data management device according to claim 2, wherein
a trajectory of the acquisition positions of the image and the underground data is acquired as the measuring line, the trajectory being specified based on accumulation of measurement values of an inertial measurement device, and
the trajectory indicating the reference measuring line is corrected such that a corresponding position on the trajectory matches with a position measured by GNSS with accuracy equal to or higher than a reference value.

9. The underground data management device according to claim 3, wherein
a trajectory of the acquisition positions of the image and the underground data is acquired as the measuring line, the trajectory being specified based on accumulation of measurement values of an inertial measurement device, and
the trajectory indicating the reference measuring line is corrected such that a corresponding position on the trajectory matches with a position measured by GNSS with accuracy equal to or higher than a reference value.

10. An underground data management method causing a computer to execute a process comprising:
acquiring an image obtained by capturing a road surface and underground data based on an intensity of reflected waves of electromagnetic waves emitted in a direction from the road surface toward an underground space, in association with acquisition positions of the image and the underground data along a plurality of measuring lines which are set such that capturing ranges of the images partially overlap;
selecting a reference measuring line from the plurality of measuring lines, dividing the image corresponding to each of the plurality of measuring lines into a plurality of blocks along the measuring line, and specifying, for each block, a relative position of each of the other measuring lines with respect to the reference measuring line by associating the block of the image corresponding to the reference measuring line and the block of the image corresponding to each of the other measuring lines such that feature points in the images match each other; and
managing, for each block, a position of the reference measuring line and the acquisition positions of the image and the underground data which are acquired along the reference measuring line in association with each other, and managing, for each block, a position of each of the other measuring lines which is specified from the relative position with respect to the reference measuring line and the acquisition positions of the image and the underground data which are acquired along each of the other measuring lines in association with each other.

11. A non-transitory storage medium storing an underground data management program for causing a computer to execute a process comprising:
acquiring an image obtained by capturing a road surface and underground data based on an intensity of reflected waves of electromagnetic waves emitted in a direction from the road surface toward an underground space, in association with acquisition positions of the image and the underground data along a plurality of measuring lines which are set such that capturing ranges of the images partially overlap;
selecting a reference measuring line from the plurality of measuring lines, dividing the image corresponding to each of the plurality of measuring lines into a plurality of blocks along the measuring line, and specifying, for each block, a relative position of each of the other measuring lines with respect to the reference measuring line by associating the block of the image corresponding to the reference measuring line and the block of the image corresponding to each of the other measuring lines such that feature points in the images match each other; and
managing, for each block, a position of the reference measuring line and the acquisition positions of the image and the underground data which are acquired along the reference measuring line in association with each other, and managing, for each block, a position of each of the other measuring lines which is specified from the relative position with respect to the reference measuring line and the acquisition positions of the image and the underground data which are acquired along each of the other measuring lines in association with each other.
